(19) United States
(12) Patent Application Publication
(10) Pub. No.: US 2009/0026279 A1
(43) Pub. Date: Jan. 29, 2009

(54) Environmental Control Enclosure

(75) Inventors: Jeremy Dittmer, Palo Alto, CA (US); Marc Finot, Palo Alto, CA (US); Mark Spencer, San Jose, CA (US)

Correspondence Address: THE MUELLER LAW OFFICE, P.C., 12951 Harwick Lane, San Diego, CA, 92130, US

(73) Assignee: SOLFOCUS, INC., Mountain View, CA (US)

(21) Appl. No.: 12/245,631

(22) Filed: Oct. 3, 2008

Related U.S. Application Data
(63) Continuation-in-part of application No. 11/639,565, filed on Dec. 15, 2006.
Application No. 11/639,565 is a continuation-in-part of application No. 12/104,415, filed on Apr. 16, 2008.
(60) Provisional application No. 60/847,870, filed on Sep. 27, 2006.
(60) Provisional application No. 61/019,586, filed on Jan. 7, 2008.

(51) Int. Cl. F24F 13/26; B21D 47/00; F24F 7/00; B01D 53/28; F24F 13/02

(52) U.S. Cl. 236/44 R; 126/704; 454/241; 454/250; 29/897.3

(57) ABSTRACT

The present invention provides an environmental control system for controlling moisture in a solar energy collector. The environmental control system facilitates the flow of air within and through the solar energy collector by using and enhancing a thermal gradient within the solar energy collector caused by exposure to sunlight. Two or more orifices are located in an enclosed solar energy system to permit air to enter, circulate and remove moisture from the system. The position of the two or more orifices and a thermal gradient generated by the solar energy collector facilitates this process.

### RELATED APPLICATIONS

This application is a continuation-in-part of the following: (1) U.S. patent application Ser. No. 11/639,565 filed on Dec. 15, 2006 entitled “Environmental Condition Control for an Energy-Conversion Unit” which claims priority to U.S. Provisional Patent Application Ser. No. 60/847,870 filed on Sep. 27, 2006 entitled “Environmental Condition Control for an Energy-Conversion Unit” and (2) U.S. patent application Ser. No. 12/104,415 filed on Apr. 16, 2008 entitled “Solar Collector Desiccant System” which claims priority to U.S. Provisional Patent Application Ser. No. 61/019,586 filed on Jan. 7, 2008 entitled “Solar Collector Desiccant System” which are hereby incorporated by reference as if set forth in full in this application for all purposes.

### BACKGROUND OF THE INVENTION

As the demand for solar energy continues to increase as a source of renewable energy, solar collectors must be designed to operate under the wide range of climate conditions which may be encountered worldwide. Solar collectors must be able to withstand exposure to moisture, such as rain, high humidity in tropical zones, and condensation in cold climates.

Solar collectors can be generally categorized into two types, flat panel technology and solar concentrators. Flat panels are large arrays of photovoltaic cells in which solar radiation impinges directly on the cells. In contrast, solar concentrators utilize optical elements such as lenses and mirrors to concentrate light onto a much smaller area of photovoltaic cell. Solar concentrators have a high efficiency in converting solar energy to electricity due to the focused intensity of sunlight, and they also reduce cost due to the decreased amount of costly photovoltaic cells required.

While flat panels incorporate very little or no air space within their systems, solar concentrators may contain a significant amount of air space due to the presence of optical elements which are used to concentrate solar radiation. A solar energy system may be comprised of one or more solar energy units in an enclosed volume. The solar energy unit may be comprised of a one or more mirrors, Fresnel lenses, planar reflectors optical prism, parabolic troughs and the like. The enclosed volume may be defined by a backpan enclosure and a transparent front cover panel. As a solar concentrator module heats and cools over the cycle of a day, moisture-laden air can be drawn into the volume of air within the enclosure. Moisture which forms on an optical component can affect the transmissive, reflective, and refractive characteristics of the component. Because solar concentrator systems focus solar radiation onto a small area, even a slight deviation in optical accuracy can greatly affect the efficiency of the system. Moisture within a solar collector can result in other problems, such as diffusion into semiconductor devices, degradation of certain coatings, and corrosion of electrical leads and other metal parts. Moisture and humidity can have an impact on solar collectors in average climates, but can pose even more of a problem in tropical climates or during inclement weather conditions.

Previous approaches for controlling or limiting the entry of moisture into a solar collector include utilizing open-air vents, sealing modules, employing desiccants, and installing filters. These approaches have numerous limitations. For example, hermetically sealed solar collectors may not maintain their seal over the lifetime of the solar collector. Designs comprising forced airflow are expensive and may prove difficult to implement. Therefore, there continues to be a need for improved moisture control systems which can function more efficiently, require little maintenance, be cost-effective, and have minimal impact on overall solar array installation.

### SUMMARY OF THE INVENTION

The present invention is an environmental control system for a solar collector. The environmental control system may comprise two or more orifices in an enclosure for a solar collection system. The orifices may facilitate the circulation of air within the enclosed solar energy collector in a way that accelerates the dehydration of the volume of air within the enclosure. The two or more orifices may be laterally, vertically or horizontally displaced. For example, two or more orifices may be located in substantially opposite quadrants of the enclosure. In another embodiment, the orifices may be placed in such a way that the solar collector enclosure possesses 180° rotational symmetry. The orifices may be covered by a filter such as a hydrophobic or oleophobic membrane, and optionally, a temperature or humidity sensitive valve or a splash guard. The environmental control system may comprise a desiccant, for example molecular sieves, silica gel, and Montmorillonite clay that may be located in the enclosed volume of the solar energy collector. A package may also be used as a barrier between the mass of desiccant and the inside atmosphere of the solar panel. By adjusting this package, the rate at which the moisture is going in and out of the desiccant is controlled, and thus the rate of desorption and absorption is controlled. Such a package may be a plastic material, a cloth material or the like. It may also have the shape and thickness of a bag.

The surface of the enclosed solar energy collector may comprise areas of differently colored pigment in order to facilitate the formation of a thermal gradient within the enclosure. The optimum size and position of the orifices of the environmental control system may be determined empirically or by utilizing information about the environment of the deployed location of the solar energy system.

In one embodiment, a computer and a computer program may be used to calculate the optimum size and position of the orifices of the environmental control system and optionally the amount of desiccant added to the enclosed solar energy collection device. The calculation may be based on the historical data of the environment of a particular geographic location. Some data used for this calculation may be, for example, the historical relative humidity, the historical yearly temperature range, the historical temperature range in a 24 hour period and the historical direct normal irradiance (DNI) of the deployed location of the solar energy system. The orifice size may be adjusted by attached caps which may have openings smaller than the orifice opening.

### BRIEF DESCRIPTION OF THE FIGURES

FIG. 1 shows a schematic of a front view of one embodiment a solar energy collector enclosure of this invention during exposure to the sun.

FIG. 2 shows a schematic of a side view of a further embodiment of a solar energy collector enclosure of this invention.

FIG. 3 shows a schematic of a front view of the embodiment of FIG. 1 under night or cloudy conditions.

### DETAILED DESCRIPTION

The present invention provides for the passive control of moisture inside an enclosed solar energy system. The invention comprises two or more orifices in an enclosure around a solar energy collection system arranged to provide for optimum air circulation to reduce the overall moisture level inside the enclosure compared to the ambient atmospheric moisture level. The orifices provide an air-permeable connection between the atmosphere in the enclosure and outside environment. The orifices may be located on the back or sides of the enclosure. The two or more orifices of this invention may be located and sized in a manner that facilitates the circulation of air within the enclosure upon exposure to a thermal gradient. The thermal gradient may be caused by the differential heating of portions of the solar energy system. The size and permeability of the orifices, the moisture capacitance inside the enclosure, and the flow path of air inside the enclosure may be modified. The invention provides for the improved balance of free convection induced by a temperature gradient, orifice geometry, and moisture capacitance inside of the module. The invention provides for the minimization of moisture inside of the solar energy system. This may result in an increased lifetime and improved performance of specific components of a solar collection device, for example the glass, semiconductor, coatings, silicone, electrical connections and lead components.

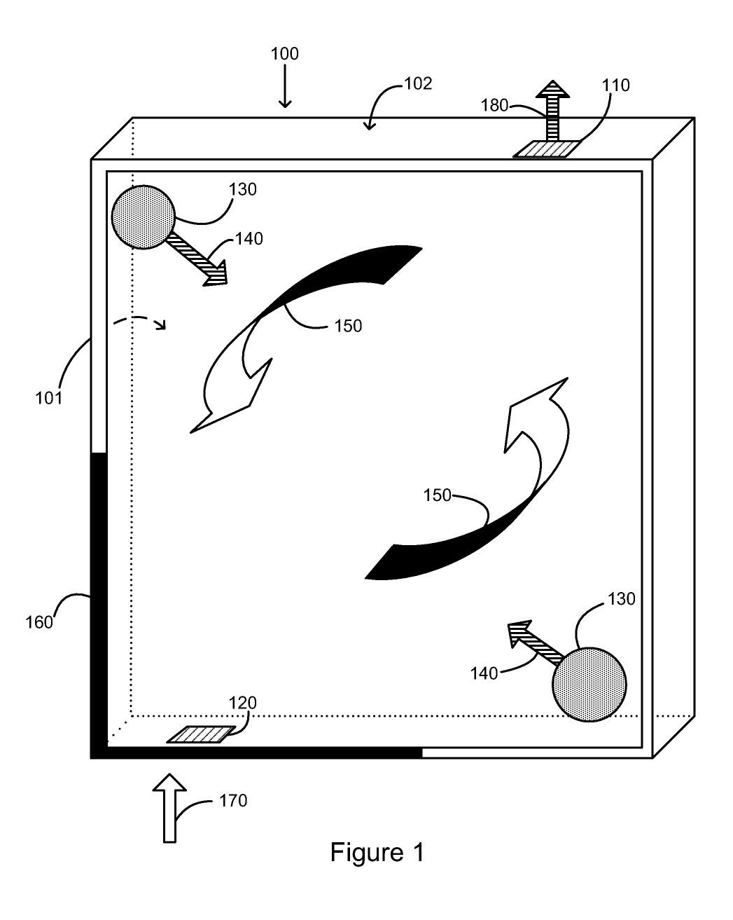

A schematic of one embodiment of this invention is shown in FIG. 1. In this embodiment, two orifices 110 and 120 are provided in an enclosure 100 surrounding a solar energy collection system (not shown). The orifices 110 and 120 may be laterally, vertically and/or horizontally displaced with respect to each other. The orifices 110 and 120 may be located on the back 101 or sides 102 of the enclosure. The orifices 110 and 120 may be, for example, in substantially opposite quadrants of the enclosed solar energy collection device. In another embodiment, the orifices 110 and 120 may be placed in such a way that the solar collector enclosure maintains 180° rotational symmetry. One aspect of this embodiment is the freedom to mount the assembled solar collector on a tracking device in any orientation while maintaining the desired air circulation in any configuration. This provides for ease of installation, as less precision is needed in the final mounting configuration. The location and geometry of the orifices 110 and 120 may facilitate the flow of air through the enclosure 100 in any orientation. The orifices 110 and 120 may have a total open area of about 100, 500, 1000, 5000 or 10,000 mm². Although FIGS. 1-3 depict an environmental control system of this invention oriented vertically, the invention may provide for improved dehydration of the volume of air within the enclosed energy collection device while the device is in any orientation. In one embodiment the orifices 110 and 120 are oriented to provide improved environmental control of an enclosed solar energy collection device while the device is dynamically oriented toward the sun. The orifices 110 and 120 may be covered by a filter. The filter may be a hydrophobic and/or oleophobic membrane, e.g. GORE™, pleated polyethersulfone (PES), polyvinylidene (PVDF), nitrocellulose-cellulose acetates (CN-CA), nylon, or any membrane filter known in the art for impeding the passage of moisture.

The size and position of the orifices 110 and 120 may be designed to maximize the airflow through the enclosure 100. The design may be determined empirically. Alternatively, the design may be determined by computer program modeling to calculate the optimum orifice size and position, as well as the amount of optionally added desiccant. In one embodiment of this invention a computer program may be used to calculate the design and position of the orifices based on historical data of the climate conditions at the deployment site of the solar energy collection device. The historical data may include the humidity and temperature, the daily humidity and temperature range, and the DNI at the deployed location of the solar energy system. The amount and composition of any added desiccant material, such as desiccant 130 of FIG. 1, used in the solar energy system may also be determined empirically or by a computer program. The size and location of the orifices 110 and 120, and optionally the amount of desiccant 130 added to the system may be adjusted to optimize moisture control in the enclosure 100 based on the geographic region that the solar energy system will be deployed. The size of orifices 110 and 120 may be adjusted by attaching caps comprising apertures of varying size. The orifices 110 and 120 may be optionally covered with a temperature-activated or a moisture-activated valve. The orifices 110 and 120 may be optionally covered with a splash guard to prevent liquid water from flowing into the enclosure 100. The orifices 110 and 120 may be optionally configured with a directional flow control apparatus such as a flapper or check valve to control the direction of the circulating volume of air within the enclosure 100.

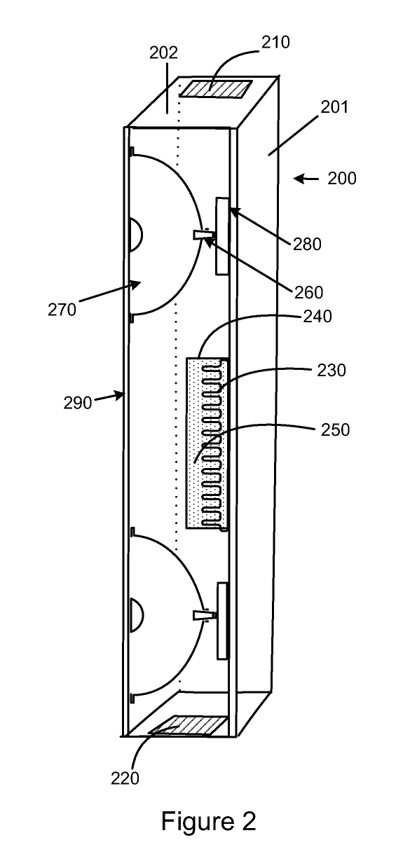

Desiccant 130 may be provided to absorb moisture in the volume of air of the enclosed energy collection device. The dehydration of desiccant 130 may be facilitated by the circulating volume of air within the enclosure 100. The orifices 110 and 120 of this invention may facilitate that circulation. FIG. 1 shows two containers with desiccant 130 provided to absorb moisture in the volume of air of the enclosure 100. In one embodiment of this invention, atmospheric moisture in the volume of air may be absorbed by a desiccant bed. In another embodiment, atmospheric moisture may be absorbed by other hydroscopic materials that comprise the solar energy system, for example a sealing material used to connect a transparent cover plate (e.g. plate 290 of FIG. 2) to the enclosure. The desiccant 130 or other hydroscopic material may be dehydrated (indicated by arrow 140) by a circular flow of the volume of air 150 which may release warm moist air 180 out of the enclosure 100 as dry air 170 flows in. The positions of the two or more orifices 110 and 120 facilitate the circular flow of air 150 during exposure to a thermal gradient of air. A thermal gradient of air may be induced in various ways during heating of the solar energy collection device by the sun. For example, in one embodiment of the invention, the solar energy collection device comprises a concentrated photovoltaic CPV unit that distributes solar energy unevenly upon exposure to sunlight in an enclosure. FIG. 2 shows the solar receiver 260, heat sink 280 and the back of the enclosure 201 which are differentially heated as the solar energy collection device is oriented toward the sun. Temperature differences between individual components of the solar collection device may also cause thermal gradients within the enclosure 200.

In a side view of one embodiment of the invention shown in FIG. 2, it can be seen that atmospheric moisture may be absorbed by added desiccant 250. The added desiccant 250 may be, for example, molecular sieves, silica gel, or Montmorillonite clay. The desiccant 250 may be distributed in one or more containers within the enclosure 200. The desiccant 250 may be arranged in porous containers 240 in a single region or multiple regions of the enclosure 200. The desiccant containers may be designed such that the entirety of the desiccant bed operates at a substantially uniform temperature. For example, the dimensions of the desiccant container 240 within the enclosure 200 can be optimized to achieve substantially uniform heat transfer throughout the desiccant bed. The desiccant containers 240 may optionally comprise fins 230 extending from the bottom of the desiccant container 240 which may increase the conduction of heat from the enclosure 200 through the desiccant 250. The desiccant container 240 may optionally comprise porous channels to facilitate the flow of air around the desiccant 250.

In the embodiment shown in FIG. 1, the formation of a thermal gradient in the enclosed volume of air may be facilitated by areas of pigment 160 applied to the surface of the enclosure 100. The pigment 160 may be applied, for example, by painting a region of the enclosure 100 with a dark or light colored paint or by affixing dark or light colored decals to different regions of the enclosure 100. Darker surfaces may preferentially warm a portion of the air in the enclosure 100 relative to lighter areas of the enclosure 100 upon exposure to sunlight. The thermal gradient generated by the differential pigmentation of the enclosure 100 may enhance the circulation of air within the enclosure 100. In one embodiment shown in FIG. 2, the solar energy system may be a concentrated photovoltaic system (CPV) system 270 which directs thermal energy to a heat sink 280 located near the rear portion 201 of the enclosure 200. Because highly concentrated light is transmitted to a receiver 260, the temperature of the rear of the enclosed CPV system may be 30-50° C. above the temperature near the front panel 290. The excess thermal energy is transmitted and dissipated by the heat sinks 280 at the rear of the enclosure 201, generating a thermal gradient in volume of air within the enclosure 200. Once a thermal gradient is formed, the volume of air within the enclosure 200 circulates as the system attempts to return to thermal equilibrium. The orifices 210 and 220 facilitate the circular flow of air by enabling hot air to escape the enclosure 200 while permitting cooler air to enter. The flow of air in combination with the position of the orifices 210 and 220 forces hot humid air out of the enclosure, while pulling in relatively cooler drier air from the outside environment.

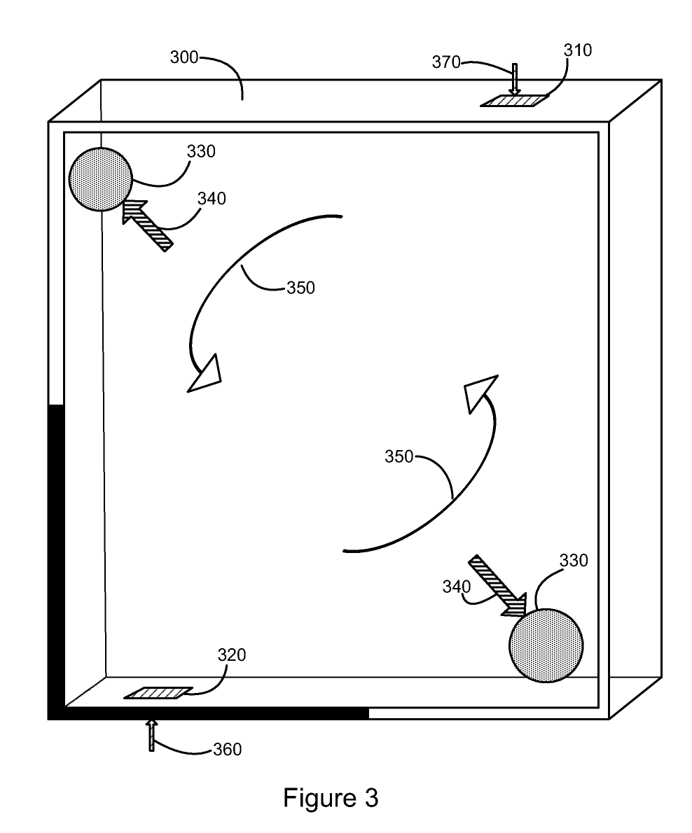

At night or during cloudy times, there may be a uniform temperature in the solar energy system and in the outside environment. These conditions are depicted in the schematic shown in FIG. 3. During times of a low temperature gradient in the enclosed solar energy system 300, air circulation 350 is reduced and moist air ingress 370 and 360 through the orifices 310 and 320 is minimized. During times of minimal thermal gradient, the desiccant 330 may absorb moisture 340 in the volume of air within the enclosure 300. One aspect of the present invention is that air circulation is facilitated by a thermal gradient and minimized in the absence of a thermal gradient. This results in a passive, robust and long-lasting climate control system that responds directly to environmental conditions.

### ADDITIONAL EXAMPLES

The difference in moisture density between the inside of an enclosed solar energy system and the ambient atmosphere was compared for four different environmental control system designs (Table 1). Alternative environmental control systems were compared to the environment control system of this invention (Design 1) in order to determine the efficiency of humidity control by the environmental control system of this invention. An environmental control system of this invention comprised of two orifices covered with a GORE™ brand hydrophobic and oleophobic membrane (Design 1) was compared to control systems comprising a single orifice of variable sizes, filters and desiccant (Designs 2-4). Moisture density was measured inside and outside of an enclosed solar energy system over four days in Hawaii and compared. The ambient moisture density varied between 14 g/m³ at night and 16 g/m³ during the day corresponding to a fluctuation of relative humidity between 60 and 80%.

Table 2 is a summary of the distribution of moisture density between the inside of the module and the ambient moisture density. A positive value corresponds to the case when the moisture density is higher inside than outside. The median value shown in Table 2 corresponds to the difference in moisture density between the inside of the solar energy system and the outside environment 50% of the time. It can be seen in Table 2 that the current invention (Design 1) provides for a lower moisture density within the enclosed solar energy system than the ambient atmosphere 50% of the time. This contrasts with single orifice designs (Designs 2-4) that result in significantly moister air inside the solar energy system than the ambient moisture density 50% of the time. It can also be seen that the Designs 2-4 provide for a much higher moisture density than Design 1 within the solar energy system 90% of the time. The experiment clearly shows that the environmental control system of this invention provides for a drier atmosphere within a solar energy system than other designs. From Table 2, it is seen that the current invention (Design 1) is significantly better than the other designs in maintaining a reduced internal moisture level.

TABLE 1
Alternative Environmental Control Designs

| | Orifices | Total Vent Area mm² | Filter | Desiccant |
|---|---|---|---|---|
| Design 1 | 2 | 3200 | GORE ™ | N |
| Design 2 | 1 | 300 | GORE ™ | N |
| Design 3 | 1 | 500 | polyester filter | Y |
| Design 4 | 1 | 1600 | GORE ™ | N |

TABLE 2
Difference in Moisture Density (g/m³) Between
Inside and Outside an Enclosed Solar Energy System
Quantile

| | | Median | | | | |
|---|---|---|---|---|---|---|
| | | (50% of | 10% of | 25% of | 75% of | 90% of |
| | Mean | time) | time | time | time | time |
| Design | −0.582 | −0.896 | ≦−4.551 | ≦−3.409 | ≦1.631 | ≦4.311 |
| 1 | | | | | | |
| Design | 4.851 | 1.49 | ≦−0.37 | ≦0.24 | ≦9.04 | ≦14.49 |
| 2 | | | | | | |
| Design | 3.522 | 1.02 | ≦−0.69 | ≦−0.15 | ≦6.91 | ≦11.31 |
| 3 | | | | | | |
| Design | 5.167 | 3.15 | ≦0.05 | ≦0.44 | ≦8.59 | ≦14.28 |
| 4 | | | | | | |

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

What is claimed is:

1. An environmental control system for a solar collector, comprising:
an enclosure;
a solar collector system within the enclosure;
a volume of air within the enclosure;
two or more orifices positioned in the enclosure, wherein the orifices are in atmospheric connection with the outside environment; and
a filter covering each of the orifices;
wherein the position of the orifices facilitates circulation of the volume of air within the enclosure.

2. The environmental control system of claim 1, wherein the solar collector system generates a thermal gradient within the enclosure.

3. The environmental control system of claim 1, wherein the filter comprises a hydrophobic membrane.

4. The environmental control system of claim 1, wherein the two or more orifices are positioned in substantially opposite quadrants of the enclosure.

5. The environmental control system of claim 1, wherein the two or more orifices are positioned in a way that the enclosure possesses 180° rotational symmetry.

6. The environmental control system of claim 1, wherein the filter comprises an oleophobic membrane.

7. The environmental control system of claim 1, further comprising a splash guard covering the filter.

8. The environmental control system of claim 1, further comprising a valve covering the filter.

9. The environmental control system of claim 1, further comprising a desiccant placed within the enclosure.

10. The environmental control system of claim 9, wherein the desiccant is selected from the group consisting of molecular sieves, silica gel, and Montmorillonite clay.

11. The environmental control system of claim 1, wherein the orifices are configured with a directional flow control apparatus.

12. The environmental control system of claim 1, wherein the enclosure further comprises a differentially colored surface.

13. The environmental control system of claim 12, wherein the differentially colored surface comprises one or more areas of dark pigment positioned asymmetrically on the enclosure.

14. A method of manufacturing a solar collection device with an internal controlled environment, the solar collection device comprising a solar collector, an enclosure, a mass of desiccant, and two or more orifices within the enclosure, the method of manufacturing comprising the steps of:
positioning two or more orifices in the enclosure;
placing the mass of desiccant in the enclosure;
placing the solar collector inside the enclosure; and
allowing a thermal gradient to generate a circulation current within a volume of air located inside the enclosure;
wherein the volume of air inside the enclosure is separate from air outside the enclosure, and wherein the volume of air is exchanged with the air outside the enclosure through the orifices.

15. The method of claim 14, further comprising the step of adjusting the area of the orifices.

16. The method of claim 15, wherein the step of adjusting the area of the orifices comprises attaching a cap to each of the orifices to reduce each of the orifice's sizes; and
wherein the caps have openings smaller than the orifices.

17. The method of claim 15, wherein the step of adjusting the area of the orifices comprises:
compiling historical relative humidity data of a geographic location; and
calculating an area of the two or more orifices.

18. The method of claim 15, wherein the step of adjusting the area of the orifices comprises:
compiling historical data of yearly temperature ranges of a geographic location;
compiling historical data of temperature ranges in a 24 hour period of the geographic location; and
calculating an area of each of the orifices for optimum placement of the two or more orifices in the enclosure.

19. The method of claim 15, wherein the step of adjusting the area of the orifices comprises:
compiling historical direct normal irradiance of a geographic location; and
calculating an area of each of the orifices for optimum placement of the two or more orifices in the enclosure.

20. The method of claim 15, wherein the step of adjusting the area of the orifices comprises:
measuring the moisture response of the enclosure under controlled environment; and
calculating an area of each of the orifices for optimum placement of the two or more orifices in the enclosure.

21. The method of claim 14, further comprising the step of adjusting the mass of desiccant.

22. The method of claim 14, further comprising the step of adjusting a package surrounding the mass of desiccant to control of rate of desorption and absorption.
